(19) United States
(12) Patent Application Publication
(10) Pub. No.: US 2007/0104242 A1
(43) Pub. Date: May 10, 2007

(54) Distributed-feedback semiconductor laser, distributed-feedback semiconductor laser array, and optical module

(75) Inventors: Koji Kudo, Tokyo (JP); Kenji Mizutani, Tokyo (JP); Kenji Sato, Tokyo (JP); Tomoaki Kato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 10/580,560

(22) PCT Filed: Nov. 12, 2004
(86) PCT No.: PCT/JP04/16838

§ 371 Date: May 26, 2006

(30) Foreign Application Priority Data
Nov. 28, 2003 (JP) 2003-399842

(51) Int. Cl. H01S 3/08

(52) U.S. Cl. 372/96

(57) ABSTRACT

A distributed-feedback semiconductor laser as a direct modulation light source with a modulation rate over 10 Gb/s having (1) a low threshold current characteristic, (2) a high single-mode characteristic, (3) a high resonant frequency (fr) characteristic, (4) a high temperature characteristic, and (5) adaptability to wide wavelength band and an extremely short active region.

The distributed-feedback semiconductor laser 1 comprises an active region 30 for generating the gain of the laser beam and a diffraction grating 13 formed in the active region 30. Out of the two front and back end surfaces sandwiching the active region 30, the front end surface 1a has a reflectivity of 1 percent or less, and the back end surface 1b has a reflectivity of 30 percent or more when viewed from the back end surface 1b toward the front. The coupling coefficient κ of the diffraction grating 13 is 100 cm⁻¹ or more, and the length L of the active region 30 is 150 μm or less. A combination of κ and L provided that Δα/gₜₕ is 1 or more is used where Δα is the gain difference between modes and gₜₕ=(internal loss αᵢ+mirror loss αₘ) is the threshold gain.

### TECHNICAL FIELD

The present invention relates to a distributed-feedback semiconductor laser, distributed-feedback semiconductor laser array, and an optical module, and particularly to a distributed-feedback semiconductor laser, distributed-feedback semiconductor laser array, and an optical module that can be used for optical communication.

### BACKGROUND ART

In recent years, as communication contents shift from telecommunications to data communications, the amount of the information that flows in the Internet traffic has been increasing drastically. Currently, a bottleneck for expanding capacity in the optical communication system is the metro access system region, and low cost direct modulation light source is in demand as a system key device.

The characteristics demanded for such a light source are:
(A) high modulation speed (>10 Gbps; in other words, a high relaxation oscillation frequency fr is needed.)
(B) low power consumption (uncooled; in other words, a high temperature characteristic is needed.)
(C) low voltage/low drive current
(D) adaptability to wide wavelength band (ranging from 1.3 μm band to 1.55 μm band)
   As lasers that meet these requirements, researches have been conducted on the following lasers: (1) direct modulation DFB laser, (2) direct modulation vertical-cavity surface-emitting laser (VCSEL), and (3) direct modulation short resonator FP laser.

For instance, as a direct modulation DFB laser of (1), an InGaAlAs DFB laser with a resonator length (active region length) of 170 to 300 μm at 1.3 μm band is reported in Non-Patent Document 1, and a relaxation oscillation frequency of 19 GHz at 85° C. is obtained by using a resonator length of 170 μm. Further, modulation of 12.5 Gbps at 115° C. with a DFB laser with a resonator length of 200 μm using dry etched diffraction grating also at the 1.3 μm band is demonstrated in Non-Patent Document 2, and sufficient performance for practical use is obtained.

Further, in terms of the VCSEL of (2), a high-speed modulation characteristic of 10 Gbps or higher with a short-wave VCSEL (780 nm to 980 nm band) is achieved (for instance refer to Non-Patent Document 3), and research and development to expand the wavelength to longer wavelength side is conducted (for instance refer to Non-Patent Document 4).

As far as the FP laser of (3) is concerned, its development history is long and attempts to make the length of resonators as short as possible using the surface forming technology by dry-etching (for instance refer to Non-Patent Document 5) have been made. In Non-Patent Document 6, a laser with a resonator length of approximately 20 μm is reported. Meanwhile structures are being optimized as well, and a frequency (fr) of 11.9 GHz is achieved at 85° C. using a laser with a resonator length of 200 μm and both surfaces HR coated as reported in Non-Patent Document 7. Further, a technique where the single-mode characteristic is improved by making the resonator length not longer than 60 μm is disclosed (for instance refer to Patent Document 1).

Moreover, a structure where the mode hop at the time of the wavelength tuning by current application is controlled and low threshold oscillation and high speed response are achieved by reducing the resonator length (active region length) of a DBR laser is disclosed (for instance refer to Patent Document 2).

Further, a structure where a monitor PD (photodiode) is monolithically integrated in a semiconductor laser is disclosed in Patent Document 3.

[Patent Document 1]

Japanese Patent No. 2624140

[Patent Document 2]

Japanese Patent Kokai Publication No. JP-P2003-46190A

[Patent Document 3]

Japanese Patent No. 2545994

[Non-Patent Document 1]

M. Aoki et al., “85° C.—10 Gbit/s Operation of 1.3-μm InGaAlAs MQW-DFB Laser,” ECOC2000 Vol. 1, pp. 123-124.

[Non-Patent Document 2]

K. Nakahara et al., “115° C., 12.5-Gb/s Direct Modulation of 1.3-μm InGaAlAs-MQW RWG DFB Laser with Notch-Free Grating Structure for Datacom Applications,” OFC2003 PDP40.

[Non-Patent Document 3]

G. Shtengel et al., “High-speed Vertical-Cavity Surface Emitting Laser,” IEEE Photonic Technology Letters, 1993, vol. 5, no. 12, pp. 1359-1362.

[Non-Patent Document 4]

A. Ramakrishnan et al., “Electrically Pumped 10 Gbit/s MOVPE-Grown Monolithic 1.3 μm VCSEL with GaInNAs Active Region,” IEE Electronics Letters, 2002, vol. 38, no. 7.

[Non-Patent Document 5]

M. Uchida et al., “An AlGaAs Laser with High-Quality Dry Etched Mirrors Fabricated Using an Ultrahigh Vacuum in Situ Dry Etching and Deposition Processing System,” IEEE Journal of Quantum Electronics, 1988, vol. 24, no. 11, pp. 2170-2176.

[Non-Patent Document 6]

T. Yuasa et al., “Performance of Dry-Etched Short Cavity GaAs/AlGaAs Multiquantum-Well Lasers,” Journal of Applied Physics, 1988, vol. 63, no. 5, pp. 1321-1327.

[Non-Patent Document 7]

T. Aoyagi et al., “Recent Progress of 10 Gb/s Laser Diodes for Metropolitan Area Networks,” SPIE, 2001, vol. 4580, APOC 2001, Beijing, China.

### DISCLOSURE OF THE INVENTION

### Problems to Be Solved By the Invention

[1] Explanation of the Problems

As described above, characteristics that roughly meet the demands of practical use can be obtained with the direct modulation DFB laser of (1) (a resonator length (active region length) about L>170 μm). However, considering a practical application, the drive current is still too high, and a driver IC that can modulate a current of several tens mA at an ultra high modulation speed of 10 Gbps or higher is needed. In other words, since the drive current is very high (>50 mA) in the conventional direct modulation DFB laser, the load on the IC is still too high.

On the other hand, the VCSEL of (2) is ones capable of becoming operable with a low drive current (threshold current Ith<1 mA, drive current Iop<10 mA) and is expected to replace the direct modulation DFB laser of (1) as a next generation light source. However, since the resonator length is too short, it is necessary to build in a low-loss high-reflection mirror in order to have it oscillate and it is not possible to have a sufficient doping level, which generates an optical loss in the mirror. Therefore, the resistance becomes high, resulting in a high drive voltage (3V or higher is needed).

Further, because the resonator volume is so small, the optical output becomes too low (2 mW or less). Another big problem is that it is difficult to have a long wavelength (it is difficult to have a wavelength longer than 1.34 [sic. 1.3] μm).

It is relatively easy to have a short resonator in the FP laser of (3), however, even if it is made as short as 20 μm as in Non-Patent Document 6, a “dynamic” single-mode characteristic and chirping characteristic that can realize transmission over 10 km at an ultra high speed modulation frequency of 10 GHz or higher cannot be obtained unless it can be made as short as the resonator of the VCSEL (<several μm).

As described above, each of the problems is basically intrinsic in the respective three types of the lasers. And from the explanations so far, one can think of the following as a first step to solve the problems. If the “dynamic” single-mode characteristic of the FP laser with an extremely short resonator can be improved, an ultra high-speed direct modulation light source with characteristics surpassing those of the VCSEL and DFB laser will be realized.

Then, how can the “dynamic” single-mode characteristic be improved? The simplest method that can be inferred would be to make the resonator length (active region length) of the DFB laser shorter, but longer than that of the VCSEL, and have a structure having both a satisfactory single-mode characteristic and low threshold current characteristic. If this could be achieved, all the aforementioned problems (1) to (3) would be solved. However, if it would be attempted to simply shorten the resonator length of the conventional DFB laser with a coupling coefficient of κ=50 cm⁻¹ (AR-AR, or HR-AR structure on both end surfaces), it would cause a drastic increase in the threshold current, and the resulting laser cannot be put to practical use. In other words, when an attempt would be done for making the resonator length of a DFB laser with a diffraction grating extremely short, a very high κ must be introduced in order to at least reduce the threshold current as mentioned in Non-Patent Document 7. However, it is unknown whether a low threshold current characteristic and high single-mode stability can coexist with such a high κ structure; it was unknown whether these characteristics can coexist at all. It is because the introduction of an extremely high κ means the wavelength dependency of the reflectance (reflectivity) of the diffraction grating is leveled (flattened), deteriorating the single-mode characteristic. As a result, the resonator of the DFB laser was able to be as short as only 170 μm as of July, 2003.

Meanwhile, a laser with a resonator length (active region length) ranging from 18 μm to 200 μm is disclosed in Patent Document 2, but this laser has a DBR structure where a diffraction grating is supplied only outside the FP active region. Since the single-mode stability of the DBR laser is basically worse than that of the DFB laser, its stability is not sufficient for the use of our purpose, which is ultra high-speed modulation. Further, since a multimode interference waveguide (MMI) must be used in the active region in the basic structure disclosed in Patent Document 2, no diffraction grating can be drawn in that area and it is impossible to make it a DFB laser as we have proposed. (It is because multimode oscillation will occur because of the multimode waveguide if a diffraction grating is formed in the MMI region.)

[2] The Object of the Invention

The present invention has been invented considering the above-described circumstances and its object is to solve all the aforementioned problems that the lasers (1) to (3) have, i.e., to achieve (I) a low threshold current (low drive current) characteristic and (II) a high single-mode characteristic simultaneously, and further achieve (III) a high fr characteristic, (IV) a high temperature characteristic, and (V) adaptability to wide wavelength band. In other words, the object of the present invention is to provide a distributed-feedback semiconductor laser (DFB laser) with an extremely short resonator (extremely short active region) having characteristics that surpass those of the conventional direct modulation DFB laser, VCSEL, and FP laser.

### MEANS TO SOLVE THE PROBLEMS

[1] The Characteristics of the Invention

A distributed-feedback semiconductor laser of the present invention comprises an active region for generating the gain of a laser beam and a diffraction grating formed in the active region, wherein out of the front and back end surfaces between which the active region is interposed, the front end surface has a reflectance of 1 percent or less, the back end surface out of the two end surfaces has a reflectance of 30 percent or more when viewed from the back end surface side toward the front, the coupling coefficient κ of the diffraction grating is 100 cm⁻¹ or more, the length L of the active region is 150 μm or less, and a combination of κ and L provided that Δα/gₜₕ is 1 or more is used where Δα is the gain difference between modes and gth is the threshold gain.

Here, there are the following cases: (i) a case where “the reflectance when viewed from the back end surface side toward the front end surface out of the front and back end surfaces between which the active region is interposed” is the same as “the reflectivity of the back end surface out of the front and back end surfaces between which the active region is interposed” (a case where there is no reflective function region behind the active region) and (ii) a case where it is the same as “the reflectance including a reflection from a reflective function region (reflector) disposed behind the active region in addition to a reflection from the back end surface out of the front and back end surfaces between which the active region is interposed.” Note that “the front end surface of the active region” is the laser emitting end surface.

Further, the gain difference Δα between modes is the mirror loss difference between the fundamental mode and an adjacent mode, and the following holds: the threshold gain gth=(internal loss αᵢ+mirror loss αₘ).

Further, the distributed-feedback semiconductor laser (DFB laser) of the present invention has an extremely short active region length compared with the conventional ones. Especially, when no reflective function is provided behind the DFB laser (for instance FIGS. 7 and 15), it may be described as “DFB laser with an extremely short resonator” since the active region length equals the resonator length. On the other hand, when a reflective function is provided behind the DFB laser (for instance FIG. 16), the active region length does not equal the resonator length. Therefore, taking the both cases into consideration, the distributed-feedback semiconductor laser of the present invention may be described as “DFB laser with an extremely short active region length” or “DFB laser of an extremely short active region length.”

In the distributed-feedback semiconductor laser of the present invention, it is preferred that the product (κ L) of the coupling coefficient κ and the active region length L be at least one and not more 3 (between 1 and 3 inclusive).

In the distributed-feedback semiconductor laser of the present invention, it is preferred that the active region length L be not longer than Lp where Lp is the length of the active region provided that the dependency of Δα/gₜₕ on the active region length L is plotted and Δα/gₜₕ is on a peak in value.

In the distributed-feedback semiconductor laser of the present invention, it is preferred that the diffraction grating have a (1) gain coupled structure, (2) loss coupled structure, (3) structure in which two or three out of the gain coupled, loss coupled, and refractive index coupled structures are mixed, or (4) a structure that is refractive index coupled and λ/4 shifted.

When the diffraction grating is refractive index coupled and λ/4 shifted, it is preferred that the λ/4 shift position is at a distance backward from the front end of the active region by 75 percent±5 percent where the back and forth-directional length of the active region is 100 percent.

Further, in the distributed-feedback semiconductor laser of the present invention, it is preferred that the back end surface of the active region be formed by etching, and the back and forth-directional length (i.e., length viewed in a direction from the back end surface to the front end surface, vice versa) of the entire device (i.e., one chip) including the distributed-feedback semiconductor laser be longer than 150 μm.

In this case, it is also preferred that the device be so structured to include another function region integrated behind the distributed-feedback semiconductor laser through an end surface gap formed by the aforementioned etching process.

Moreover, it is preferred that the aforementioned function region have a light-receiving function in these cases.

Further, when the aforementioned function region has a light-receiving function, it is preferred that its front end surface be formed tilted relative to the back end surface of the active region.

Further, it is also preferred that the function region have the function to reflect light to the active region side. In other words, “the reflectivity of the back end surface side toward the front end surface out of the front and back end surfaces between which the active region is interposed” becomes “a reflectivity including a reflection from a reflective function region disposed behind the active region in addition to a reflectivity of the back end surface out of the front and back end surfaces between which the active region is interposed” in this case.

Further, in the distributed-feedback semiconductor laser of the present invention, it is preferred that the reflectivity of the back end surface of the active region be set to not less than 90 percent.

Concretely, it is possible to have the back end surface of the active region have a reflectance of 90 percent or more by, for instance, providing a high-reflection film on the back end surface of the active region.

In this case, it is preferred that a window that guides light out from the active region be formed on the high-reflection film.

Further, in the distributed-feedback semiconductor laser of the present invention, it is preferred that the materials that constitute the active region comprise at lease one of the following: Al, N and Sb.

Further, it is preferred that the distributed-feedback semiconductor laser has a series resistance of 50 ohms±10 ohms.

Further, a distributed-feedback semiconductor laser array of the present invention is characterized by monolithically comprising an array of the distributed-feedback semiconductor lasers of the present invention and the wavelengths of the distributed-feedback semiconductor lasers are different from one another.

Further, an optical module of the present invention is characterized by comprising the distributed-feedback semiconductor laser of the present invention or the distributed-feedback semiconductor laser array of the present invention.

[2] Operation

(1) The Derivation of an Indicator for the Single-Mode Stability

In the present invention, the derivation of an indicator necessary to evaluate the single-mode stability of a distributed-feedback semiconductor laser (DFB laser) having an extremely short resonator (i.e., with an extremely short active region) must be explained first because it is inappropriate to evaluate by using the conventional indicator for the DFB laser of the present invention.

As an indicator to evaluate the single-mode stability of a DFB laser, side mode suppression ratio (SMSR—expressed in dB) has been experimentally and widely used, and as more directly understandable parameters, Δα[cm-1] (the mirror loss difference between the basic mode and an adjacent mode) or Δα·L (Δα multiplied by the resonator length i.e., the active region length L) have been used in analysis. These indicators were sufficient to evaluate the conventional DFB laser with a resonator length L of an order of 200 to 600 μm because there were facts obtained through experimentation (the relationship between experimentally obtained single-mode yield and design parameters) etc. However, when trying to optimize the structure of a DFB laser in which the resonator is designed to be unconventionally and extremely short, as in the case of the present invention, the same indicators cannot be applied, at all.

For instance, let's assume that a Δα·L value of 0.5 be needed to obtain sufficient single-mode stability for a conventional DFB laser with a resonator length L of 250 μm. If Δα necessary to realize the same value 0.5 with another DFB laser with a resonator length L of 50 μm is derived using Δα·L as the indicator, Δα must be quintupled, compared with the case where L=250 μm, and this cannot be regarded right at all. Further, it is questionable to use only Δα for evaluating the single-mode stability of the DFB laser with an extremely short active region, which needs introduction of a high κ (i.e., the mirror loss curve is leveled (flattened) and Δα has a tendency to decrease).

Therefore, the present inventor has derived an indicator for evaluating the single-mode stability that can be satisfactorily applied to a laser having an extremely short active region and whose correlation with device parameters is clear. In doing so, the basic equation of the SMSR was revisited and reviewed.

The SMSR is expressed by the ratio of light output P (λn) between the main mode (wavelength λ0) and the next strongest side mode (=adjacent mode, wavelength λ1) as in the following equation (1).

$$\begin{matrix}[ EQUATION 1 ] & \\ SMSR = \frac{P ( {λ}_{0} )}{P ( {λ}_{1} )} & ( 1 )\end{matrix}$$

Further, each light output is expressed by the following equation (2).
P(λₙ)=F₁v_{g}αₘ(λₙ)Np(λₙ)hvVₚ (2)

In equation (2) above, the symbols are as follows: F1: end surface output on one side/total light output, vg: group velocity, αₘ: mirror loss, Np: photon density, h: Planck's constant, and Vp: the volume of the resonator.

The SMSR can be further expressed by equation (3) below.

$$\begin{matrix}[ EQUATION 3 ] & \\ SMSR = \{ \frac{{g}_{th , 0}}{{g}_{th , 1}} + \frac{Δα + Δ g}{{g}_{th , 1} \cdot {β}_{sp}} \cdot ( \frac{I}{{I}_{th , 0}} - 1 ) \} & ( 3 )\end{matrix}$$

Here, gth: threshold gain, Ith: threshold current, βsp: naturally emitted light coefficient, and gth is the sum of internal loss αᵢ and mirror loss αₘ. As for suffixes 1 and 0, 0 means the main mode and 1 side mode. When the ratio with the threshold current I/Ith, 0 is fixed, the SMSR is a function between the gain and the loss and it does not depend on the active region length L. Here, when approximating (Δg to 0) that the gain does not depend on the frequency i.e., wavelength, the equation of the SMSR can be transformed into the following equation (4).

$$\begin{matrix}[ EQUATION 4 ] & \\ SMSR = \frac{1}{\frac{Δα}{{g}_{th , 0} + 1}} + \frac{\frac{Δα}{{g}_{th , 0}}}{( \frac{Δα}{{g}_{th , 0}} + 1 ) \cdot {β}_{sp}} \cdot ( \frac{I}{{I}_{th , 0}} - 1 ) & ( 4 )\end{matrix}$$

In other words, the SMSR can be expressed as a function of Δα/gₜₕ,0.

FIG. 1 shows the dependency of the SMSR on Δα/gₜₕ when αᵢ=20 cm⁻¹ and βsp=5×10⁻⁵. As shown in FIG. 1, the bigger Δα/gₜₕ gets, the more the SMSR increases and so does the single-mode stability. Further, the SMSR increases steeply when Δα/gₜₕ is between 0 to 1, however, the increase starts to be more gradual once Δα/gₜₕ passes 1. Δα/gₜₕ=1 physically means that, in order to oscillate, the side mode requires a gain twice as much as the main mode does. For instance, since the SMSR is 46 dB when I/Ith=5 and Δα/gₜₕ=1, high single-mode stability can be expected in a range of Δα/gₜₕ>1. This newly discovered parameter “Δα/gₜₕ” is an indicator whose correlation with device structure parameters is very clear since it has Δα, which has conventionally been used as an indicator for single-mode stability, as its numerator and gₜₕ, which is directly connected to the threshold current, as its denominator. This is the indicator that should be used for evaluating the DFB laser with an extremely short active region length.

Accordingly in the present invention, the parameter Δα/gₜₕ is used as the indicator for evaluating single-mode stability, and we have discovered that the DFB laser with an extremely short active region length can obtain high single-mode stability when it is structured to have a Δα/gₜₕ of 1 or greater. Hereinafter, a device structure in which such high single-mode stability and a low threshold current characteristic can coexist will be concretely described.

(2) The Reflectances of Resonator End Surfaces (The Reflectance of Front and Back End Surfaces Sandwiching the Active Region)

The reflectances of the both end surfaces of the resonator and the λ/4 shift position are the parameters to be considered first when devising a plan to improve single-mode stability. The both end surfaces must have anti (low) reflectance (AR)—reflectances of 1 percent or less—in order to achieve highest single-mode stability in the DFB laser. However, at least one end surface out of the front and back end surfaces between which the active region is interposed must have a high reflectance (HR) not less than that of the cleaved edge (R of about 30 percent) in order to have a low threshold current with the extremely short active region length because the reflectance of the diffraction grating does not provide sufficient reflectance, even with a high-κ diffraction grating. In other words, an AR end surface with a reflectance of 1 percent or less and an end surface with a reflectance of 30 percent or more are required. Moreover, for the purpose of achieving a low threshold current, it is very effective to have the end surface with a reflectance of 30 percent or more have a much higher reflectance of 90 percent or more by forming a high-reflection film such as a dielectric multilayer film, and metal film etc. on it.

The back end surface of the active region may have a reflectance of 30 percent or more (preferably 90 percent or more), however, this reflectance of 30 percent or more (preferably 90 percent or more) may be realized by including a reflection portion from a reflective function region disposed behind the active region.

Moreover, it is important to discover a structure in which a high single-mode yield can be obtained while keeping the above-described structure (out of the front and back end surfaces between which the active region is interposed, the front end surface has a reflectance of 1 percent or less and the back end surface has a reflectance of 30% or more when viewed from the back end surface side towards the front). Of course, many reports have been made in terms of the analysis of such an asymmetrical end surface structure as far as the DFB laser with a conventional resonator length (about 300 μm) is concerned, and the guidelines for obtaining a high single-mode yield have been reported. However, since it was unclear whether or not the same guidelines could be applied to the DFB laser with an extremely short active region as in the case of the present invention, this was investigated using the Δα/gₜₕ parameter.

The calculations were performed for the following structures: (1) structure with an asymmetrical λ/4 (the λ/4 position is at the 25: position on the HR side when the active region is divided in a ratio of 25:75 in the back and forth direction, i.e., along the optical path) and reflectances of 90 percent (for HR) and 0 percent (for AR), (2) structure without λ/4 shift and with reflectances of 90 percent (for HR) and 0 percent (for AR), and (3) structure without λ/4 shift and with reflectances of 90 percent (for HR) and 30 percent (for CL). Note it has been known that the structure (1) provides the highest single-mode yield in the case of the normal DFB laser (with a resonator length of 200 to 600 μm). The parameters used in the calculations are: L=50 μm, κ=400 cm⁻¹, effective refractive index n=3.226, diffraction grating period 203.04 nm, carrier life time τs=5×10⁻⁹ s, internal loss αᵢ=20 cm⁻¹, and βsp=5×10⁻⁵.

A total of 32 devices were obtained by equally dividing the HR end surface phase in eight from 0 to π and the CL end surface phase in four from 0 to π. After Δα/gₜₕ for each device was calculated, the single-mode yield was evaluated in terms of the percentage of the devices with a Δα/gₜₕ value of 1 or greater. FIG. 2 shows the calculation results.

As evident from FIG. 2, the similar tendency to the case of the conventional DFB laser is estimated about the DFB laser with an extremely short resonator of the present invention; the best yield of 59 percent was obtained with the asymmetrical λ/4 structure. While the mirror loss αₘ was smaller (i.e., lower threshold current) in the HR-CL structure than in the asymmetrical λ/4 structure, no result that satisfied Δα/gₜₕ>1 was obtained and the yield was 0 percent in the HR-CL structure. As a result, the following fact has been confirmed: that is, as in the case of the conventional DFB laser, at least the asymmetrical λ/4 structure in which the active region is divided in the ratio of 25:75 is effective as a basic structure that provides a high single-mode yield in the DFB laser even with an extremely active region length like the present invention. Note that the allowable deviation for the λ/4 shift position preferred in order to keep the asymmetrical λ/4 structure effective is for instance approximately ±5 percent or less.

In the above descriptions, we assumed that the diffraction grating of the distributed-feedback semiconductor laser (DFB laser) of the present invention is solely refractive index coupled. In this case, we have shown that having a λ/4 shift and having the λ/4 shift position in the active region located at 25:75 (a quarter) of the length of the region away from the back are effective. However, the similar effect (high single-mode yield) can be obtained without the λ/4 shift when the diffraction grating is gain coupled or loss coupled, or has a structure in which the gain coupled, loss coupled, and refractive index coupled structures are mixed.

Out of these diffraction gratings, the gain coupled diffraction grating, the loss coupled diffraction grating, and the refractive index coupled diffraction grating with the λ/4 shift provide a theoretical single-mode yield of 100 percent. Although the diffraction grating with a structure in which two or three out of the gain coupled, loss coupled, and refractive index coupled structures are mixed does not provide a theoretical single-mode yield of 100 percent, it is capable of providing a yield close to that and its single-mode yield is greatly improved compared with a pure refractive index coupled diffraction grating other than a structure with a λ/4 shift.

Next, it will be explained how long the active region length should be and what coupling coefficient should be used in order to achieve higher single-mode stability together with a low threshold current characteristic in practical use with the above-described end surface structure and a λ/4 shift.

(3) Coupling Coefficient κ, Active Region Length (Resonator Length) L

We focus on the single-mode stability of the DFB laser with an extremely short active region length and will derive the coupling coefficient κ and the active region length L to achieve the optimal structure. The indicator Δα/gₜₕ fundamentally includes the internal loss αᵢ parameter, therefore the dependency on αᵢ must be taken into consideration. The value of αᵢ is between several cm⁻¹ and 25 cm⁻¹, as lower limit and upper limit, respectively, depending on the thickness of the active layer and the doping concentration in the manufacturing of lasers. Therefore, we must investigate the subject with this range in mind.

A model of the DFB laser with an extremely short active region length used for our calculation is shown in FIG. 3. Reflectances of 90 percent (HR) and 0 percent (AR) are assumed and a ratio of L1:L2=25:75 is used.

We investigated the dependency of Δα/gₜₕ on the active region length L for various κ values when αᵢ is 25 cm⁻¹ (the upper limit) and FIG. 4 shows the results. While the κ value for the conventional direct modulation DFB lasers is in an order between 50 to 60 cm⁻¹, for instance with κ=50 cm⁻¹, Δα/gₜₕ is 1 or less for any active region length L. Further, when it is in the order of κ=50 cm⁻¹, the dependency of Δα/gₜₕ on the active region length is moderate and Δα/gₜₕ is not influenced by L that much. On the other hand, when κ is 100 cm⁻¹ or more and the active region length is 150 μm or less, there are regions where Δα/gₜₕ is greater than 1. Typically speaking, in the DFB lasers having high κ values of 100 cm⁻¹ or more, the bigger κ is, the more likely that Δα/gₜₕ surpasses 1 and shows a peak on the side where the active region length is shorter. The region where Δα/gₜₕ exceeds 1 shifts such that the bigger κ is, the shorter the active region length becomes and the bigger this peak value per se becomes. In other words, when increasing κ and shortening the active region length, it is necessary to use a precise combination of the active region length L and κ since Δα/gₜₕ depicts (a curve of) a sharp peak.

What has become clear, here, is that a region where Δα/gₜₕ>1 can be achieved by having a κ value of 100 cm⁻¹ or more and an L value of 150 μm or less even in case where αᵢ is 25 cm⁻¹, which is assumed to be the upper limit.

Next, we investigated the dependency of Δα/gₜₕ on the active region length L for various κ values when αᵢ is 5 cm⁻¹ (the lower limit) and FIG. 5 shows the results. When κ is 50 cm⁻¹ (the conventional value), Δα/gₜₕ>1 can be achieved with the active region length L of 150 μm or more. However, when the active region length L is 150 μm or less, Δα/gₜₕ is 1 or less. However, by having κ value of 100 cm⁻¹ or more, Δα/gₜₕ can be much greater than 1 in a region where L is not longer than 150 μm.

As described above, a structure having a κ value of 100 cm⁻¹ or more and an L value of 150 μm or less is an effective combination that provides high single-mode stability especially in the DFB laser with an extremely short active region length, and this is effective with a wide range of internal loss values from several cm⁻¹ (lower limit) to 25 cm⁻¹ (upper limit). And thus the lower limit of the active region length L can be defined as a length at which the Δα/gₜₕ becomes 1 or less for certain internal loss αᵢ.

Now, there is another effect that must be taken into consideration regarding the above-described combination of κ and L: a deterioration of single-mode stability accompanied by the axial direction spatial hole burning phenomenon when driven above the threshold current. The axial direction spatial hole burning phenomenon basically depends on the axial direction light intensity distribution in the active region. In the case of a DFB laser with the end surface structure (AR-HR) and with a λ/4 shift position already determined, the light intensity distribution is determined only by the absolute value of the product (κ L) of the coupling coefficient κ and the active region length L. The κ L value should be set in a range of 1 or more and 3 or less in order to suppress the influence of the axial direction spatial hole burning and achieve a more stable operation.

(4) Threshold Current

Now we will analyze the compatibility with the low threshold current characteristics to focus on a parameter effective in decreasing the threshold current. That is, we try to find a device parameter in order to have a stable single-mode characteristic and a low threshold characteristic coexist.

We calculated the threshold current (Ith) for various κ values and for only those L values that satisfy Δα/gₜₕ of 1 or greater, when αᵢ=20 cm⁻¹, and FIG. 6 shows the results.

Although a value of Δα/gₜₕ cannot be 1 or greater at any active region length when κ=50 cm⁻¹, the results when κ=50 cm⁻¹ is shown as a reference to show the case of the conventional DFB laser structure.

Further, the symbol (point) on each curve in FIG. 6 indicates the active region length L value at which the value of Δα/gₜₕ peaks for each κ. From these calculation results, we found out that the threshold current is lowest at the active region length L value with which the value of Δα/gₜₕ peaks. With the same L, the bigger κ is, the more the threshold current decreases. A threshold current equal to or lower than one third of that of the reference structure was estimated at κ=300 cm⁻¹.

The reasons why the threshold current is decreased in the DFB laser with an extremely short active region length are the following two: (1) the current necessary for oscillation as the absolute value decreases in a region with a short L because of the reduction in volume, (2) since a high reflectance can be obtained in a structure with a high κ, the threshold gain decreases and so does the threshold current. Here, the reduction in volume is very effective in obtaining a high relaxation oscillation frequency fr, therefore, taking a high fr characteristic into consideration, the optimal active region length should be a range of the length long enough to obtain Δα/gₜₕ>1 but not longer than a resonator length at which Δα/gₜₕ peaks.

(5) Other Structural Designs to Promote the Advantages the DFB Laser with an Extremely Short Active Region Length

A structure of the DFB laser with an extremely short active region length that is effective in further improving the device characteristics, in addition to the combination of the coupling coefficient κ and the active region length L, will be described.

In the present invention, the active region length is extremely shortened to 150 μm or less. In such a structure, cleaving the both end surfaces which is conventional is very difficult. Also there is a problem in handling. In other words, even if the cleavage is achieved, it will be very difficult to handle it upon mounting it on a module if the length of the entire device including the distributed-feedback semiconductor laser (DFB laser) is 150 μm or less. However, it is preferred that the front end surface of the active region be a flat cleaved surface so that an anti-reflective coating can be applied to lower the reflectance to be 1 percent or less. In sum, one of the end surfaces must be a cleaved surface.

In consideration of the situation described above, the back end surface of the active region, which must have a reflectance of 30 percent or more, is formed by etching in the present invention because it is well possible to apply a coating to achieve a reflectance of 30 percent or more even though the surface is not entirely flat (i.e., has certain irregularities). For instance, a metal electrode film for injecting current can be used as a high-reflection film. By forming the back end surface by etching, the active region length of the DFB laser is maintained to be 150 μm or less, and the length of the entire device (the back and forth length) becomes longer than 150 μm and should be set to an appropriate length according to the ability of the handling device. The appropriate length is, for instance, 170 μm or more, approximately.

Forming the back end surface by etching creates another merit: integration of another function region. In the present invention, the DFB laser region length is 150 μm or less and the device length is set to an order of a length of a conventional single function light source, longer than 150 μm, in consideration of handling, therefore a high function integrated device can be realized with a small size and a high value can be added to the device if another function region is integrated in the extra region created by the length difference. In the present invention, the other function integrated through an end surface gap formed by etching is, for instance, a light-receiving function for monitoring. In this case, the front end surface of the function region is formed tilted relative to the back end surface of the active region in the present invention so that the back end surface of the active region is not parallel to the opposing front end surface of the function region in order to suppress the reflection return to the DFB laser (the active region, the optical waveguide or path) from the integrated function region.

Such a structure is easily realized by forming also the end surface of the integrated other function region by etching as well.

Note that the structure in which a monitor PD (photodiode) is monolithically integrated in a semiconductor laser is disclosed in Patent Document 3. However, integrating a monitor PD in the DFB laser with an extremely short active region as in the present invention offers more advantages because the monitor function can be added while keeping the length of the entire device nearly the same as that of the conventional semiconductor laser. Further, the reflection return from the adjacent monitor PD hinders the stable operation of the laser unless the reflection return is suppressed by having the back end surface of the DFB laser (the end surface facing the monitor PD) have a relatively high reflectance and tilting the front end surface of the monitor PD (facing the DFB laser) relative to the end surface of the DFB laser as in the present invention. The merits of the present invention stemmed from the end surface shape structure and small integrated device are obtainable in the case where a function region other than a monitor PD is integrated as well. In other words, according to the present invention, it becomes possible to decrease the entire size of an integrated device, increase the device yield from a wafer, and reduce costs.

Further, in the present invention, it is preferred to form a diffraction grating in the integrated function region and let it have a light reflecting function. In this case, it is not necessary to form the high-reflection film on the back end surface of (the active region of) the DFB laser. Further, by appropriately selecting the composition of the optical waveguide (path) for the region having the light reflecting function while taking the oscillation wavelength of the laser into consideration, a light receiving function can be given additionally to the light reflecting function.

Note the following. When the back end surface of the DFB laser is coated with a high-reflection film and has a high reflectance, a light output window (window for guiding light) is formed in the present invention by etching and removing a part of the high-reflection film to an extent that the reflectance does not deteriorate in order to take out (guide out) an amount of light sufficient for monitoring to the monitor PD in the back.

Meanwhile, as materials for constituting the DFB laser with an extremely short active region, materials from which a high temperature characteristic can be expected e.g., Al materials such as AlGaInAs, Nitride included materials such as GaInNAs or Sb included materials work effectively by combining them with the optimized structure of κ and L etc. as described above.

For modulating the DFB laser with an extremely short active region at high speed, in consideration of the impedance matching with 50 ohm driving systems, it is preferred to set the parameters of doping concentration and clad layer thickness etc. so that the series resistance of the laser is just 50 ohms±10 ohms in the present invention, taking advantage of a characteristic of an extremely short resonator i.e., high resistance.

In addition, it is effective, too, to create an array. In other words, by having the DFB lasers with an extremely short active region monolithically arrayed and creating a DFB laser array in which the wavelength of each DFB laser is different from one another, a multi-wavelength light source for a wavelength division multiplexing system can be provided at low cost in the present invention.

Further, by creating an optical module including at least the DFB laser or the DFB laser array, the product can be provided as a module in the present invention.

MERITORIOUS EFFECT OF THE INVENTION

A first effect is that it is possible to provide a distributed-feedback semiconductor laser with an extremely short active region and high single-mode stability that can oscillate with a low threshold current because the distributed-feedback semiconductor laser comprises the active region for generating the gain of the laser beam and a diffraction grating formed in the active region, out of the front and back end surfaces between which the active region is interposed, the front end surface has a reflectance of 1 percent or less, the back end surface out of the two end surfaces has a reflectance of 30 percent or more when viewed from the back end surface side toward the front, the coupling coefficient κ of the diffraction grating is set to 100 cm⁻¹ or more, the length L of the active region is set to 150 μm or less, and a combination of κ and L of when Δα/gₜₕ is 1 or more is used where Δα is the gain difference between modes and gₜₕ is the threshold gain.

A second effect is that it is possible to provide a distributed-feedback semiconductor laser with an extremely short active region wherein the influence of the axial direction spatial hole burning is suppressed by setting the product of the coupling coefficient κ and the active region length L anywhere between 1 and 3 inclusive in addition to the structure described above, and a more stable single-mode operation is realized when operated equal to or later [sic. above] the oscillation threshold to obtain a high output characteristic.

A third effect is that it is possible to provide a distributed-feedback semiconductor laser with an extremely short active region having a high relaxation oscillation frequency fr in addition to a stable single-mode operation and a low threshold current by having the active region length L be not longer than Lp where Lp is a length of the active region when the dependency of Δα/gₜₕ on the active region length L is plotted and Δα/gₜₕ is the peak value, in addition to the structure described above.

A fourth effect is that it is possible to provide a distributed-feedback semiconductor laser with an extremely short active region having a high single-mode yield because the diffraction grating formed in the active region is gain coupled or loss coupled, or has a structure in which two or three out of the gain coupled, loss coupled, and refractive index coupled structures are mixed, or is refractive index coupled and λ/4 shifted.

A fifth effect is that it is possible to provide a distributed-feedback semiconductor laser with an extremely short active region having a still higher single-mode yield. It is particularly because the diffraction grating formed in the active region is refractive index coupled and is of a λ/4 shifted structure, and the λ/4 shift position is by 75 percent±5 percent behind from the active region provided that the back and forth-directional length of the active region is 100 percent.

A sixth effect is that it is possible to provide a distributed-feedback semiconductor laser with an extremely short active region wherein the difficulty in cleaving in a distributed-feedback semiconductor laser with an extremely short active region and the difficulty in handling are overcome by forming the back end surface of the active region by etching and having the back and forth-directional length of the entire device including the distributed-feedback semiconductor laser longer than 150 μm.

A seventh effect is that it is possible to provide a distributed-feedback semiconductor laser with an extremely short active region wherein a still high functionality is realized and a high value is added by having the device include another function region integrated behind the distributed-feedback semiconductor laser via an end surface gap formed by the aforementioned etching process.

An eighth effect is that it is possible to provide a distributed-feedback semiconductor laser with an extremely short active region wherein a monitor PD is integrated by giving a light-receiving function to the integrated other function region.

A ninth effect, which is enhancing the eight effect, is that it is possible to provide a distributed-feedback semiconductor laser with an extremely short active region wherein a stable distributed-feedback laser operation is realized by forming the front end surface of the other integrated function region tilted relative to the back end surface of the active region and suppressing the reflection return from the other function region into the active region.

A tenth effect is that the necessity to form a high-reflection film on the back end surface of the active region is eliminated and more amount of backward light for the monitor can be outputted by having the other function region integrated have a reflection function. Further, it is possible to provide a compact, monitor-PD integrated distributed-feedback semiconductor laser with an extremely short active region by having the other function region have a light-receiving function along with the reflection function.

An eleventh effect is that it is possible to provide a distributed-feedback semiconductor laser with an extremely short active region having an even lower threshold current by setting the reflectivity of the back end surface of the active region to 90 percent or more. In order to set the reflectivity of the back end surface of the active region to 90 percent or more, for instance, a high-reflection film may be formed on the back end surface.

A twelfth effect is that it is possible to provide a distributed-feedback semiconductor laser with an extremely short active region wherein a sufficient amount of backward light is efficiently taken out by forming a window for guiding light that guides light out from the active region in the high-reflection film provided on the back end surface of the active region.

A thirteenth effect is that it is possible to provide a distributed-feedback semiconductor laser with an extremely short active region having an excellent high temperature operation characteristic by including at least one of the following types of materials: Al, N, and Sb, as materials making up the active region.

A fourteenth effect is that it is possible to provide a distributed-feedback semiconductor laser with an extremely short active region that can easily be impedance matched with 50 ohm systems when the laser is modulated at high speed by setting the series resistance of the distributed-feedback semiconductor laser to 50 ohms±10 ohms.

A fifteenth effect is that it is possible to provide a multi-wavelength light source for a wavelength division multiplexing system at low cost by having the distributed-feedback semiconductor laser of the present invention monolithically arrayed and creating a distributed-feedback semiconductor laser array in which the wavelength of each distributed-feedback semiconductor laser is different from one another.

A sixteenth effect is that it is possible to provide a light source having high single-mode stability, a low threshold current, and a high fr characteristic in the form of a module easily manageable by a system builder further by creating an optical module comprising the distributed-feedback semiconductor laser of the present invention or the distributed-feedback semiconductor laser array of the present invention.

### BRIEF DESCRIPTION OF THE DRAWINGS

FIG. 1 is a drawing showing the dependency of the side mode suppression ratio SMSR on Δα/gₜₕ.

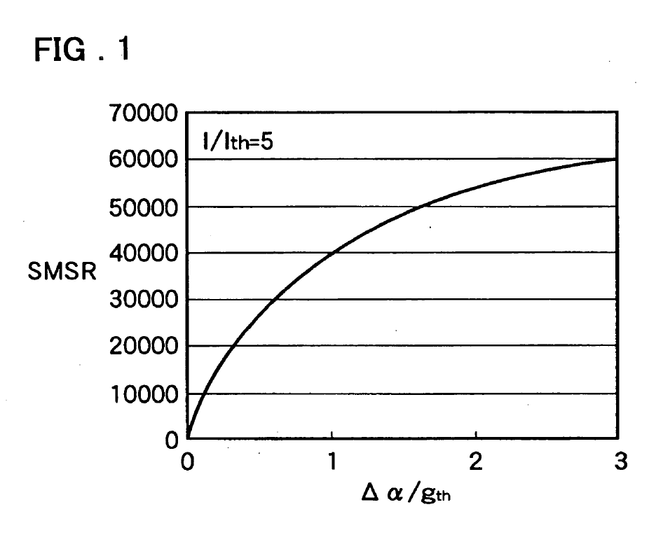

FIG. 2 is a drawing showing the single-mode yields of DFB lasers of various structures.

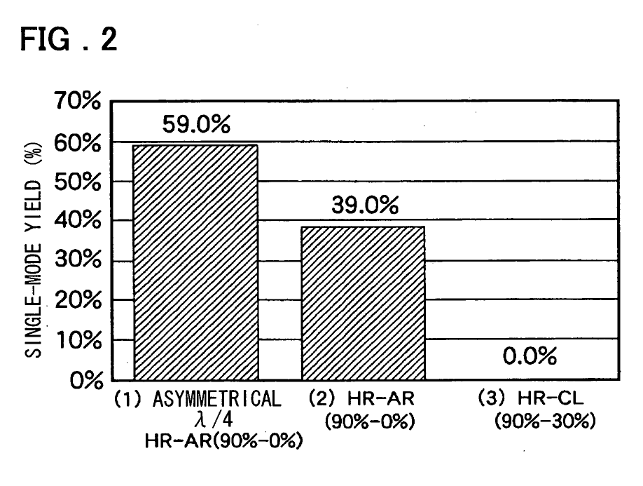

FIG. 3 is a drawing showing a model of a DFB laser.

FIG. 4 is a drawing showing the dependency of Δα/gₜₕ on the active region length L for various κ values when the internal loss αᵢ is 25 cm⁻¹.

FIG. 5 is a drawing showing the dependency of Δα/gₜₕ on the active region length L for various κ values when the internal loss αᵢ is 5 cm⁻¹.

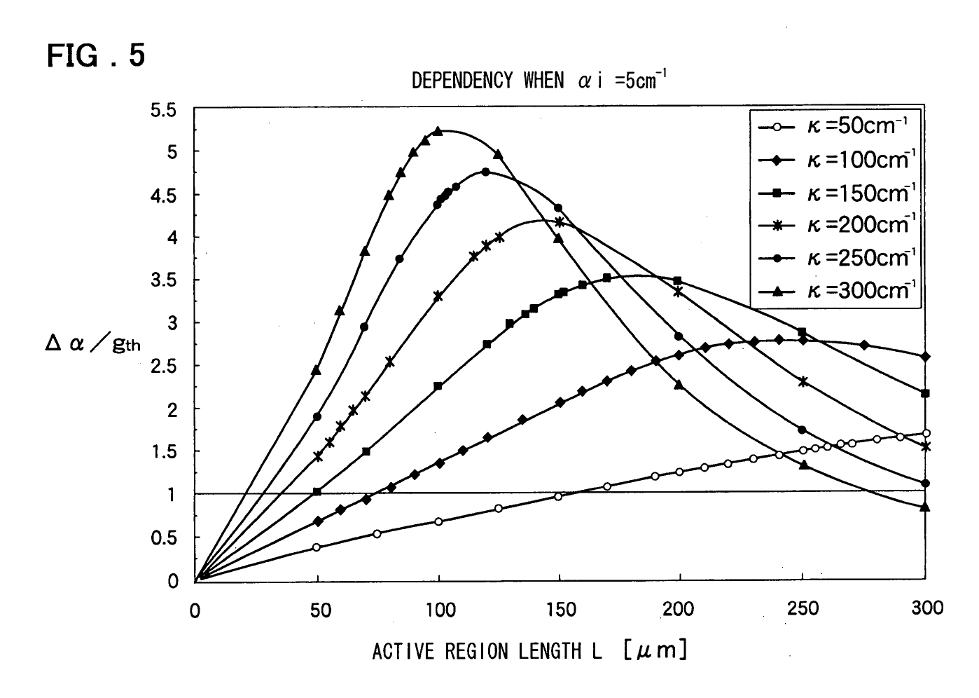

FIG. 6 is a drawing showing the dependency of the threshold current at which Δα/gₜₕ is 1 or greater on the active region length L.

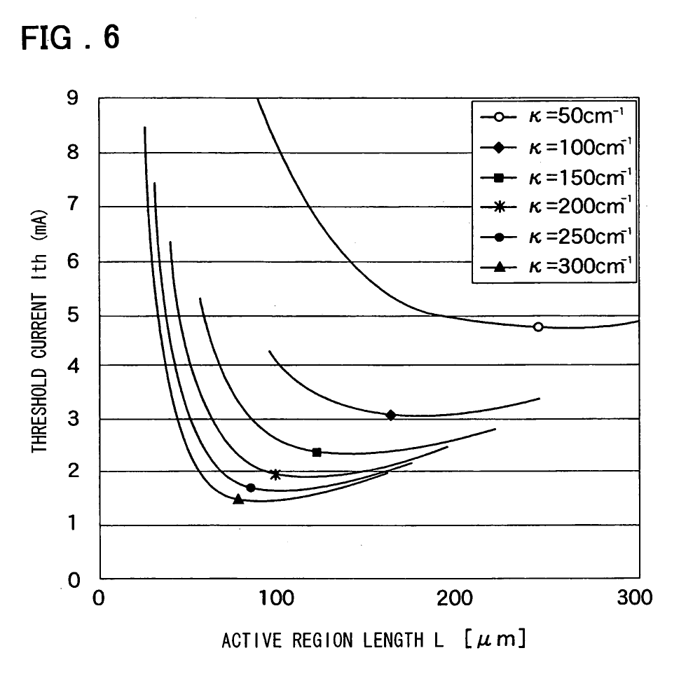

FIG. 7 is a schematic perspective view showing the structure of a DFB laser monolithically integrated with a monitor PD relating to a first embodiment of the present invention.

FIG. 8 is a schematic top plan view of the device shown in FIG. 7.

FIG. 9 is a schematic perspective view for explaining the diffraction grating formation and the growth of MQW-SCHs in the manufacturing process of the device shown in FIG. 7.

FIG. 10 is a schematic perspective view for explaining the growth of a p-InP clad and p+-InGaAs cap in the manufacturing process of the device shown in FIG. 7.

FIG. 11 is a schematic perspective view for explaining the formation of a waveguide mesa in the manufacturing process of the device shown in FIG. 7.

FIG. 12 is a schematic perspective view for explaining the growth of a high resistance InP blocking layer in the manufacturing process of the device shown in FIG. 7.

FIG. 13 is a schematic perspective view for explaining a device division in the manufacturing process of the device shown in FIG. 7.

FIG. 14 is a schematic perspective view for explaining the formation of electrodes in the manufacturing process of the device shown in FIG. 7.

FIG. 15 is a schematic perspective view showing the structure of a DFB laser relating to a second embodiment of the present invention.

FIG. 16 is a schematic perspective view showing the structure of a DFB laser monolithically integrated with an external reflector relating to a third embodiment of the present invention.

FIG. 17 is a schematic perspective view showing the structure of a laser array relating to a fourth embodiment of the present invention.

FIG. 18 is a schematic drawing showing a state in which the laser array shown in FIG. 17 and an AWG multiplexer are hybrid-integrated.

### EXPLANATIONS OF SYMBOLS

1: distributed-feedback semiconductor laser

1a: front end surface

1b: back end surface

2: monitor PD (the other function region having a light-receiving function)

3: external reflector (the other function region having a reflection function)

13: diffraction grating

18a: p electrode for the DFB laser (a part of it constitutes a high-reflection film.)

29: device

30: active region

31: λ/4 shift position

35: device

33: device

34: arrayed device (distributed-feedback semiconductor laser array)

GL: gap length (end surface gap)

MOST PREFERRED MODE FOR CARRYING OUT THE INVENTION

Next, embodiments relating to the present invention will be described in detail with reference to the drawing.

### FIRST EMBODIMENT

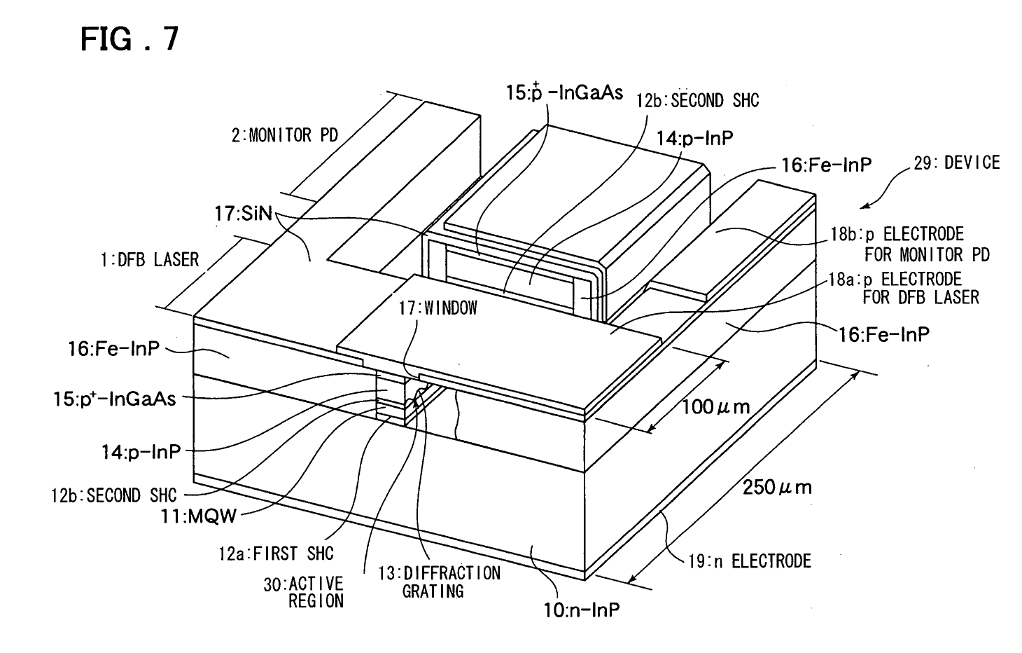

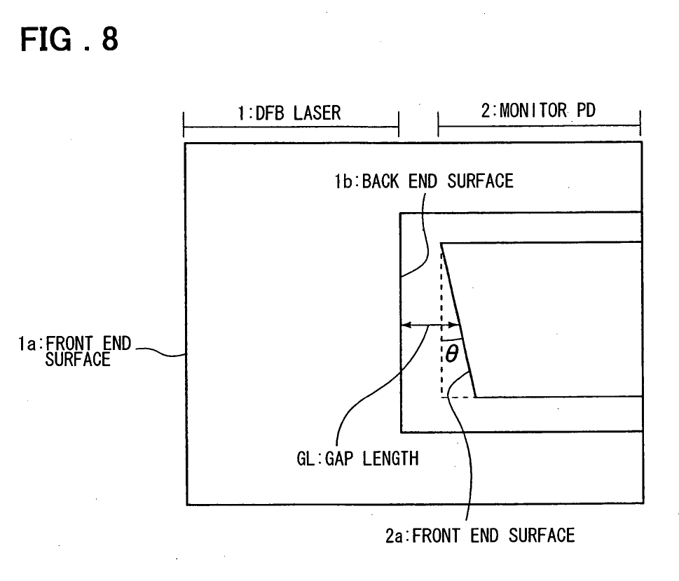

Referring to FIG. 7, a perspective view of a device 29 in which a DFB laser (distribution-feedback semiconductor laser) 1 and a monitor PD2 (another function region having a light-receiving function) are integrated in one unit is shown as a first embodiment of the present invention. Further, FIG. 8 is a schematic top plan view of the device 29 shown in FIG. 7. In FIG. 7, an Fe doped InP current blocking layer 16 is partially broken to be perspective so that the layer structure of the DFB laser 1 can be shown. Further, a SiN film 17 formed on the front end surface of the monitor PD2 is shown to be perspective in order to show the layer structure of the monitor PD2 in FIG. 7

As shown in FIGS. 7 and 8, the device 29 comprises the monolithically integrated DFB laser 1 (distribution-feedback semiconductor laser) and the monitor PD 2.

The back and forth-directional (longitudinal) length of this device 29 is, for instance, 250 μm. In other words, the total length of the device including the DFB laser 1 is longer than 150 μm. Further, the back and longitudinal length of the DFB laser 1 (and an active region 30 of the DFB laser 1) is, for instance, 100 μm. Thus, the active region length is much shorter than the conventional one.

Further, since the DFB laser 1 does not have a reflection function in the back in the case of the present embodiment, the DFB laser 1 of the present embodiment can be described as “DFB laser having an extremely short resonator.” Moreover, since an example in which there is no reflection function region in the back of the active region 30 is being described in the present embodiment, “the reflectance when looking towards the front from a back end surface 1b side out of two front and back end surfaces 1a and 1b between which the active region 30 is interposed” is a reflectivity of the back end surface 1b in the case of the present embodiment.

The DFB laser 1 comprises ten layers of InGaAlAs multiple quantum well (MQW) 11 provided on an n-InP substrate 10, AlGaInAs/AlInAs/InGaAsP separate confinement heterostructures (SCH) 12a and 12b, an optical waveguide having a refractive index coupled structure, including a λ/4 shifted diffraction grating 13, a p-InP clad layer 14, a p+-InGaAs cap layer 15, an Fe doped high resistance InP 16, a SiN 17 as an insulating film for preventing current flow (the SiN 17 is used as a PD passivation film as well), p electrode 18a for the DFB laser, and n electrode 19 (the n electrode 19 is used by the monitor PD 2 as well).

Further, the active region 30 is formed of MQW 11 and the diffraction grating 13.

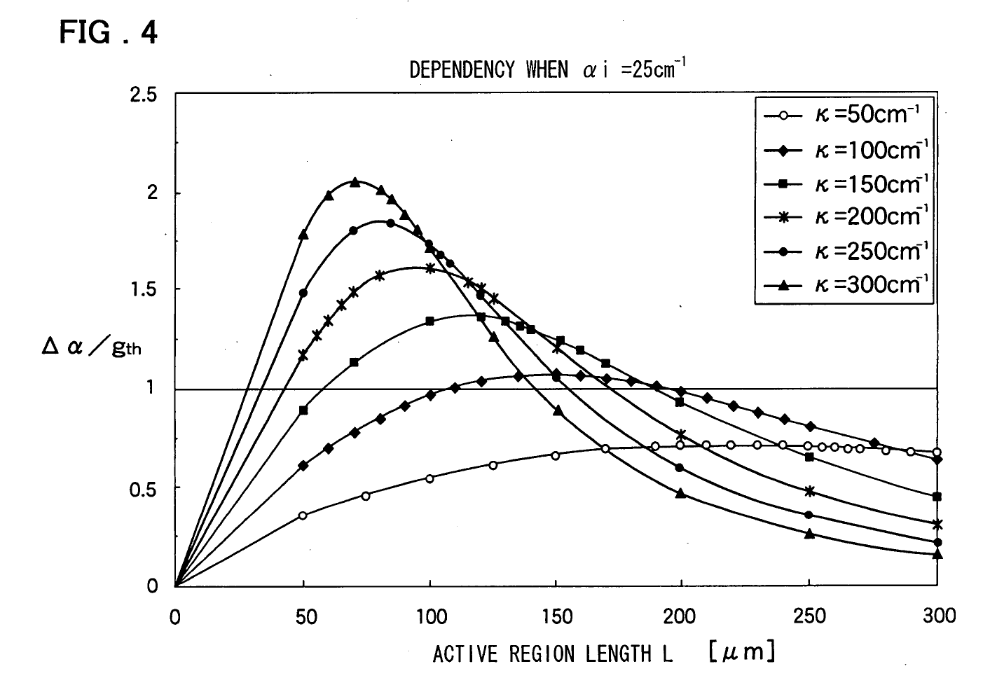

Here, regarding the layer structure of the present embodiment, the carrier density of each single layer that constitutes the MQW 11 is reduced and the multilayer MQW is employed in order to improve the differential gain, however, since an internal loss of 20 cm⁻¹ is rather high, the coupling coefficient of the diffraction grating 13 is set to 200 cm⁻¹, referring to the graph shown in FIG. 4, and the back and forth-directional length of the active region 30 is set to 100 μm.

In other words, κ is set to 100 cm⁻¹ or more, and L is set to 150 μm or less where κ is the coupling coefficient of the diffraction grating 13 and L is the back and forth-directional length of the active region 30. Further, a combination of κ and L that makes Δα/gₜₕ=1 or more is employed where Δα is the gain difference between modes and gₜₕ is the threshold gain. Moreover, the product of the coupling coefficient κ and the active region length L is at least 1 and 3 or less. In addition, the active region length L is not longer than Lp where Lp is a length of the active region at which Δα/gₜₕ is the peak value, when the dependency of Δα/gₜₕ on the active region length L is plotted.

Further, in the present embodiment, the back end surface 1b (refer to FIG. 8) of the DFB laser is formed by ICP dry etching and a high reflectance (for instance 95 percent or more) of the back end surface 1b is obtained by coating this back end surface 1b with a metal multilayer film of Ti/Pt/Au that constitutes the p electrode 18a for the DFB laser.

Meanwhile, the front end surface 1a (refer to FIG. 8) of the DFB laser is formed by cleavage and is coated with an anti-reflection AR coating with a reflectance of 0.1 percent or less (not shown in the drawing).

In other words, out of the two front and back surfaces between which the active region 30 is interposed, the reflectance of the front end surface 1a is set to 1 percent or less and that of the back end surface 1b is set to 30 percent or more.

In the structure of the present embodiment as described above, since Δα/gₜₕ becomes sufficiently 1 or more and the κ L value is 2, the axial spatial hole burning effect could be controlled. Therefore, a stable single-mode operation (SMSR>50 dB) and a low threshold current operation (<2 mA) could be realized. Further, a front optical fiber output of 3 mW or more and a high fr characteristic of 20 GHz and higher would be obtained by a drive current of 40 mA or more, and a ultra high-speed, ultra-high performance direct modulation light source with low drive current and low drive voltage has been realized.

Meanwhile, regarding the optical output monitor from the back end surface 1b, since the back end surface 1b is metal-coated in the present embodiment, it was predicted that the emission power from the back end surface 1b towards the back would be reduced because of the absorption of the metal. Therefore, the monitor PD2 is integrated so that the leaked light is detected. Integrating the monitor PD2 has a merit of making the size of the device 29 suitable for handling while efficiently utilizing an extra region of the device 29.

Further, in order to increase the input power to the monitor PD2, it is effective to adjust the shape of the electrode coating on the back end surface 1b of the DFB laser 1 and partially provide a light output window (window for guiding light; not shown in the drawing) while making sure that the reflectance does not decrease. For instance, the light output window is formed by removing a rectangular-shaped electrode with a width of 2 μm from the part that covers the back end surface 1b of the DFB laser 1 of the p electrode 18a for the DFB laser at a position 4 μm laterally away from the optical waveguide.

Further, the integrated monitor PD2 has the same basic layer structure and composition wavelength as the DFB laser 1, however, the end surface of the monitor PD2 on the laser side (i.e. the front end surface 2a facing the DFB laser 1—refer to FIG. 8) is formed tilted relative to the back end surface 1a of the DFB laser 1 as shown in FIG. 8, and not parallel to the back end surface 1a, in order to suppress the reflection return to the optical waveguide of the DFB laser 1. Here, a tilted angle θ is set according to a gap length (end surface gap) GL between a back end surface 30a [sic. 1a] of the DFB laser 1 and the front end surface 2a of the monitor PD2 so that the reflection return does not return to the optical waveguide of the laser. In the present embodiment, the gap length GL is for instance about 50 μm and the tilted angle θ is for instance 10 degrees.

By using the monitor PD2 integrated in the DFB laser 1 as described above, a sufficient monitor output current to control the auto power control operation of the DFB laser 1 could be obtained. Further, the total device length of the device 29 is 250 μm, which is equal to the conventional 10-G direct modulation DFB laser. In other words, a high value-added direct modulation light source with a light monitor function has been realized with the conventional device size. Furthermore, a frequency fr of 20 GHz or higher is obtained with a drive current of 40 mA or more, however, necessary voltage and current can be reduced even more in the case of 10-Gbps operation, reaching a level where it is possible to drive it with an ultra high-speed 10-G-CMOS driver. As a matter of fact, satisfactory characteristics have been obtained at an operation frequency of 10 GHz as an uncooled direct modulation light source module with the light source of the present invention and a CMOS LD driver built in, realizing a lower cost module including the driver.

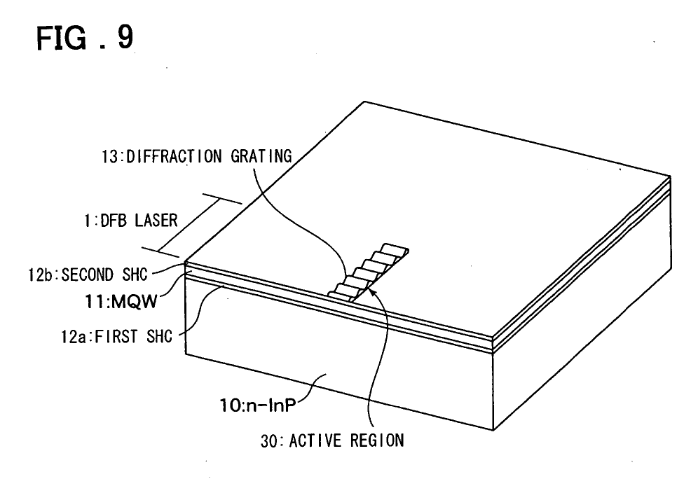

Next, a manufacturing method will be described with reference to FIGS. 9 to 14.

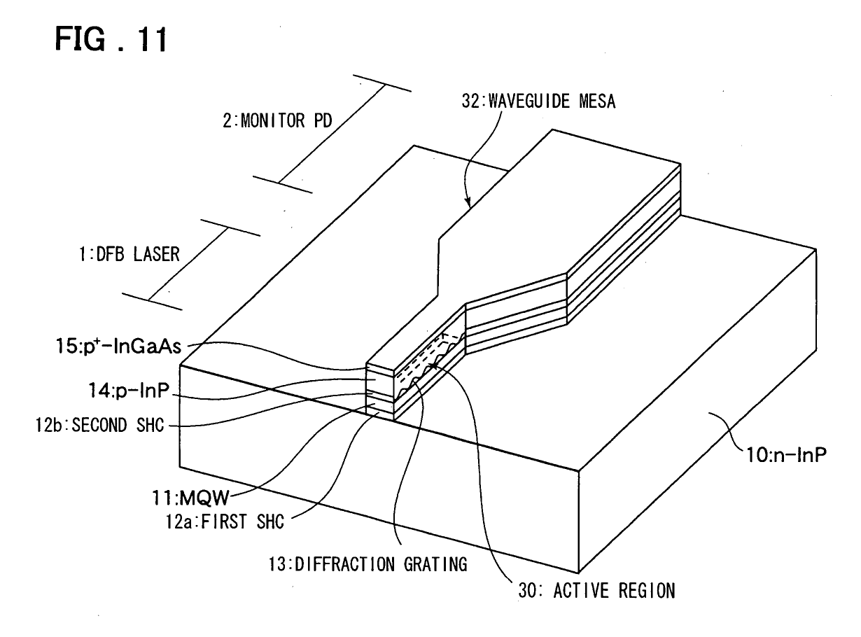

Further, in FIGS. 9 to 13, formation regions for the DFB laser 1 are indicated as “DFB laser 1” even though the drawings show a state in which the DFB laser 1 is not formed yet. Similarly, in FIGS. 11 to 14, formation regions for the monitor PD2 are indicated as “monitor PD2” even though the drawings show a state in which the monitor PD2 is not formed yet. Further, only the single device part is shown in FIGS. 9 to 14 for the sake of convenience, however, it is in a wafer state until it is cut out by cleavage for instance.

First, as shown in FIG. 9, an n-InGaAlAs first SCH layer 12a (100 nm thick), a n-InGaAlAs well (5 nm thick) having a compression strain of 1 percent, a ten-layer MQW11 comprising a InGaAlAs barrier (5 nm thick) having a tensile strain of 1 percent, a second SCH layer 12b comprising InGaAlAs (50 nm thick)/InAlAs (50 nm thick)/InGaAsP (150 nm thick), and an extremely thin p-InP cover layer (not shown in the drawing; 50 nm thick) are grown in the order on an n-InP substrate 10 using the organo-metal vapor phase epitaxial growth method.

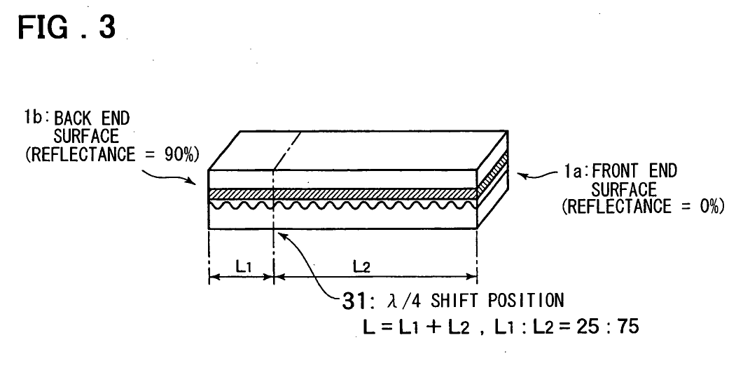

Next, the diffraction grating pattern (not shown in the drawing) of the diffraction grating 13 having a λ/4 shift is drawn on the p-InP cover layer (not shown in the drawing) only for the formation region of the DFB laser 1 using the EB lithography. Here, the diffraction grating period is for instance approximately 200 nm, and the distance of a λ/4 shift position 31 (refer to FIG. 3) from the front end of the DFB laser 1 is 75 μm±5 μm behind thereof. In other words, the diffraction grating 13 is of the refractive index coupled structure and the λ/4 shifted structure, and the distance of the λ/4 shift position 31 is 75 percent±5 percent behind from the front end of the active region 30 provided that the back and forth-directional length of the active region 30 is 100 percent.

Then, the diffraction grating pattern drawn as described above is transferred to a semiconductor by dry etching. Here, the depth of the diffraction grating is for instance approximately 100 nm, and the dry etching process for the diffraction grating pattern is stopped at the InGaAsP layer of the second SCH layer 12b so that it does not reach the layer that includes Al (i.e., the InAlAs layer of the second SCH layer 12b). This is for avoiding problems caused by the oxidation of the layer that includes Al. As shown in FIG. 9, a wafer on which the diffraction grating 13 is partially formed (only in the formation region of the DFB laser 1) can be obtained as described above.

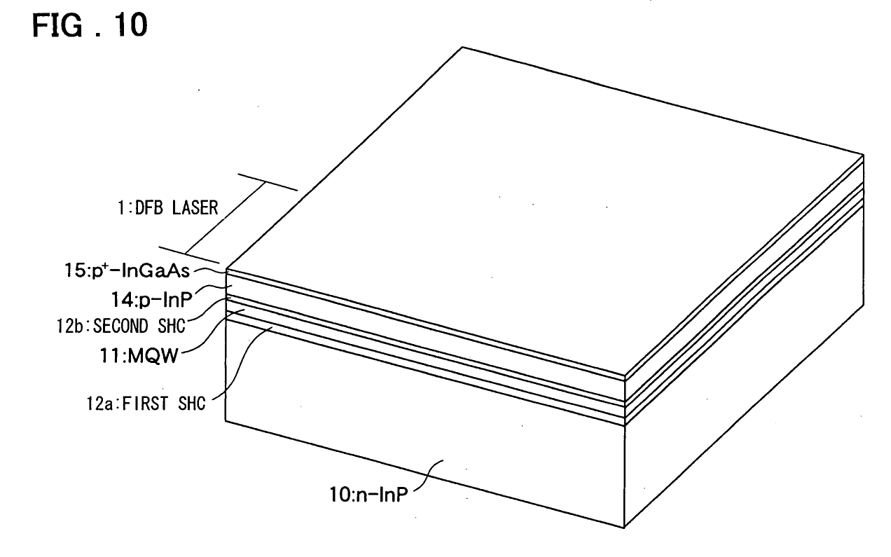

Next, as shown in FIG. 10, using the organo-metal vapor phase epitaxial growth method, a p-InP clad layer 14 having a thickness of, for instance, 2 μm, and a p+-InGaAs cap layer 15 having a thickness of 300 nm are grown in the order on the wafer, on which the diffraction grating 13 is partially formed.

Next, as shown in FIG. 11, a waveguide mesa 32 that includes regions for the DFB laser 1 and the monitor PD2 is formed by dry etching. In other words, the layers from the p+-InGaAs cap layer 15 to the first SCH layer 12a are removed by dry etching leaving the mesa that includes the formation regions for the DFB laser 1 and the monitor PD2. Here, the width of the waveguide mesa 32 (the length in the direction perpendicular to the waveguide direction) is for instance 1.5 μm in the formation region of the DFB laser 1, and in the formation region of the monitor PD2, it is for instance 50 μm in order to have a big light receiving area.

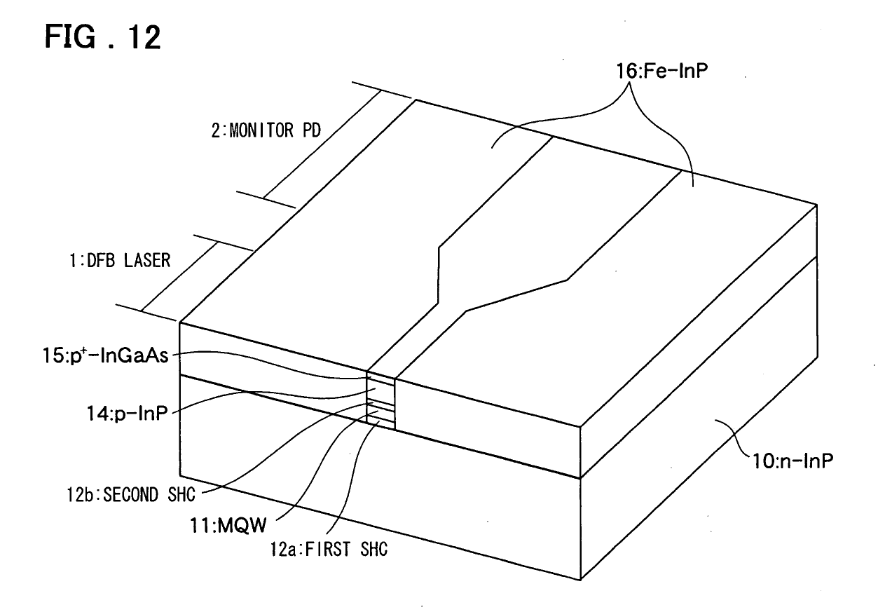

Next, as shown in FIG. 12, using the organo-metal vapor phase epitaxial growth method, the Fe-doped InP current blocking layers 16 having the same height as that of the waveguide mesa 32 are grown on the both sides of the waveguide mesa 32. Note that, in the present embodiment, the Fe-doped InP current blocking layer 16, which is made to have high resistance by doping Fe, is used as a current blocking layer, however, for instance Ru can also be used as a dopant.

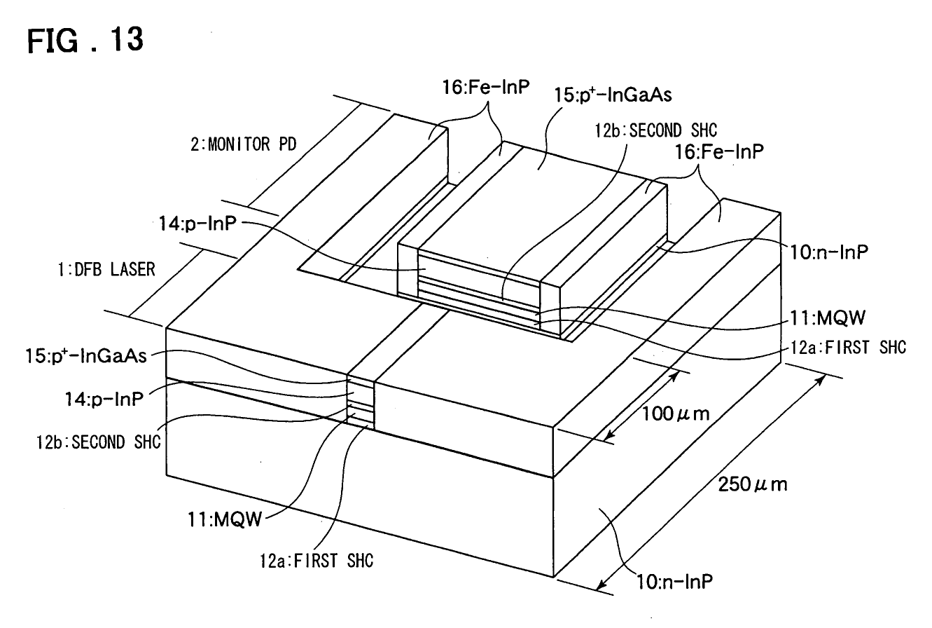

Next, as shown in FIG. 13, the waveguide mesa 32 is divided into the DFB laser 1 and the monitor PD2 by etching out an U-shaped part around the monitor PD2 using dry etching. Note that only the outer layer of the n-InP substrate 10 is removed by the etching process. The back end surface 1b of the DFB laser 1 (it is also the back end surface of the active region 30 in FIG. 8) and the front end surface 2a of the monitor PD2 (FIG. 8) are formed by this etching process.

The front end surface 2a of the monitor PD2 is tilted, by for instance, 10 degrees or more relative to the back end surface 1b of the DFB laser 1 so that it is not parallel to the back end surface 1b of the DFB laser 1 as shown in FIG. 8. Further, the distance between the DFB laser 1 and the monitor PD2 (the gap length GL) is approximately 50 μm.

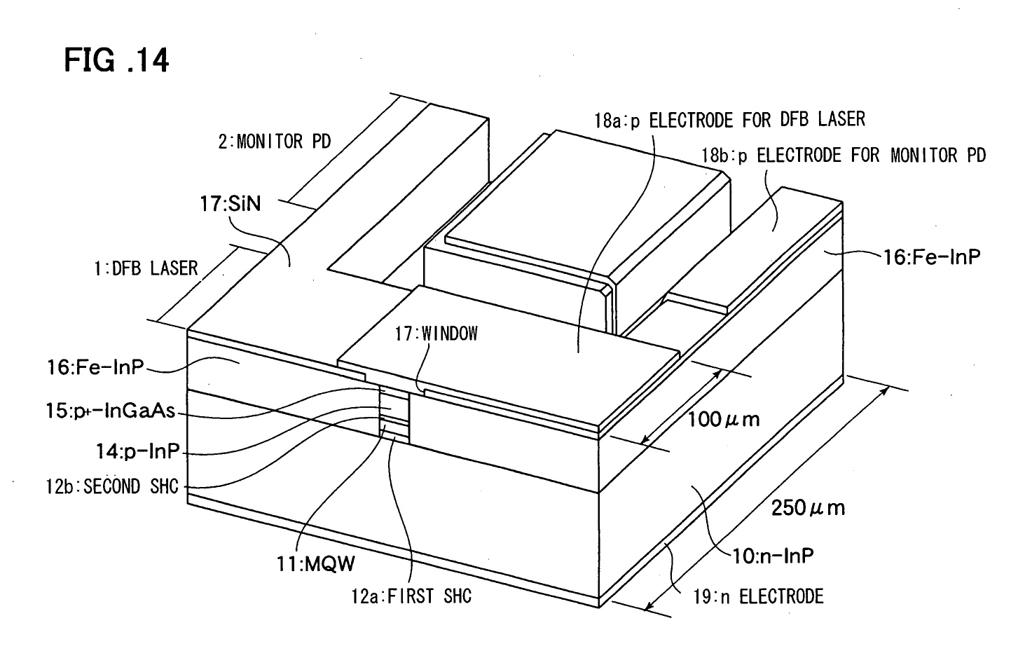

Next, as shown in FIG. 14, the SiN film 17 is formed on the entire upper surface of the device 29. This SiN film 17 functions as an insulating film for preventing current flow and passivation film.

Next, a window 17a for injecting current is opened in the region of the DFB laser 1 on the SiN film 17, and a window for extracting current (not shown in the drawing; the same shape as the window 17a) is opened in the region of the monitor PD2.

Next, as shown in FIG. 14, the p electrode is formed on the upper surface of the device 29.

In other words, the p electrode 18a for the DFB laser is formed so that it covers the SiN film 17 in the region of the DFB laser 1 and the p+-InGaAs cap layer 15 through the window 17a for injecting current formed on the SiN film 17.

Here, the p electrode 18a for the DFB laser is formed of, for instance, TiPtAu. This p electrode 18a for the DFB laser is formed so that it covers the back end surface 1b of the DFB laser 1 as well. By doing this, a high reflectance of 90 percent or more can be obtained as the reflectivity of the back end surface 1b of the DFB laser 1.

Further, the p electrode 18a for the DFB laser is formed in the smallest possible area. By doing this, since the capacitance of the p electrode 18a for the DFB laser can be made sufficiently small, the modulation frequency that we are trying to achieve with the DFB laser 1 can be obtained.

Meanwhile, a p electrode 18b for the monitor PD is similarly formed in the region of the monitor PD2 so that it covers the SiN film 17 and the p+-InGaAs cap layer 15 through the window for extracting current (not shown in the drawing) formed on the SiN film 17.

Further, after the back of the wafer is polished, the n electrode 19 is formed on this back surface. Note that this n electrode 19 is for both the DFB laser 1 and the monitor PD2. The polishing process on the back of the wafer is performed until the thickness of it becomes an order of between 100 μm and 350 μm in order to make the cleavage process easier.

At this point, the device manufacturing process in the wafer state is completed.

Next, after devices are cut out from the wafer by cleavage, normal anti-reflective coating is applied en bloc to the front end surfaces of all the DFB lasers 1, which are still one unit, in the bar state (array state). As a result of this anti-reflective coating, a reflectance of 1 percent or more could be obtained as the reflectance of the front end surface of the DFB laser 1.

Further, this is divided into devices each having one DFB laser 1 and one monitor PD2, completing the device manufacturing process.

Note that the series resistance of a single unit DFB laser 1 was approximately 8 ohms.

Since the size of the device 29 of the present embodiment is 250 μm in length and 250 μm in width, approximately the same as the conventional DFB laser, the total yield from a 2-inch wafer is approximately 20,000 devices, and the device yield is 60 percent. The number of good products was 12,000, which is a very favorable result. The characteristics obtained is as mentioned above.

According to the first embodiment described above, the aforementioned first through ninth effects and the eleventh to thirteenth effects can be obtained.

Further, in the first embodiment described above, an example in which the materials for the optical waveguide (the materials that constitute the active region 30) include Al-system materials was shown, however, the present invention is not limited to this example and N-system materials such as GaInNAs/GaAs etc. can similarly be used as well. In this case, since the devices can be made from a GaAs wafer as a base, the merit that a bigger wafer is used in the process can be enjoyed. Further, the materials for the optical waveguide may be Sb materials. By including at least one of Al, N or Sb-system materials in the materials that constitute the active region 30, the aforementioned thirteenth effect can be obtained.

Further, in the first embodiment described above, the series resistance of the DFB laser 1 can be increased to an order of 50 ohms±10 ohms by reducing the doping concentration of the p-InP clad 14, or further reducing the mesa width of the DFB laser 1 from 1.5 μm, or further shortening the active region length, and by doing so, the aforementioned fourteenth effect can be obtained.

### SECOND EMBODIMENT

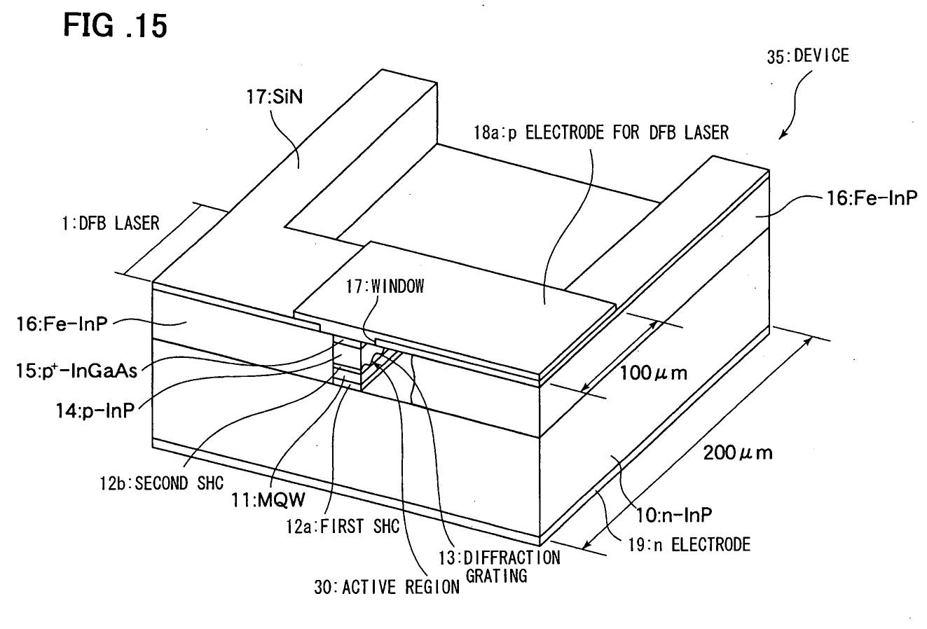

In the first embodiment, an example in which the DFB laser 1 and the monitor PD2 are integrated in one unit is described, however, the present invention is not limited to this, and for instance, a device 35 that only has the DFB laser 1 can be used as shown in FIG. 15. In other words, the only difference between the device 35 relating to a second embodiment and the device 29 shown in FIG. 7 is that the device 35 does not have the monitor PD2.

In order to obtain the device 35 relating to the second embodiment shown in FIG. 15, while the waveguide mesa (not shown in the drawing) only having the region of the DFB laser 1 is formed in the etching process at the stage shown in FIG. 11, all the processes for forming the monitor PD2 are omitted.

In the case of the device 35 shown in FIG. 15, the total back and forth-directional length of the device 35 can be further reduced to, for instance, 200 μm, and a dielectric multilayer film (not shown in the drawing) can be used as the high-reflection film on the back end surface 1b of the DFB laser 1 instead of the p electrode 18a for the DFB laser.

According to the second embodiment, the first to sixth effects mentioned above, and the eleventh to thirteenth effects can be obtained.

### THIRD EMBODIMENT

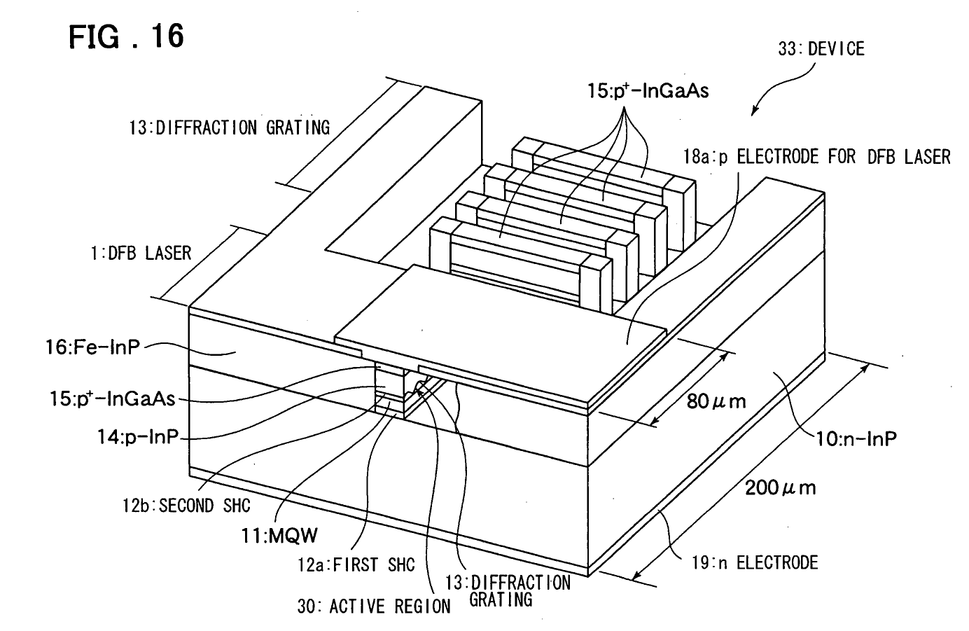

Further, in the aforementioned first embodiment, a device 33 into which an external reflector 3 divided into multiple parts is integrated can be created as shown in FIG. 16 by performing an etching process creating thin rectangles in an appropriate period (pitch) in the region of the monitor PD2 after the state shown in FIG. 13 has been achieved. The arrangement period for each divided part of the external reflector 3 is, for instance, 400 nm, approximately twice as much as the region of the DFB laser 1. Here, the end surface (the front and back) of each divided part of the external reflector 3 must be parallel to the back end surface 1b of the DFB laser 1 unlike the case with the monitor PD2, and the aforementioned etching process creating thin rectangles must be performed likewise.

When the external reflector 3 is integrated as shown in FIG. 16, the high-reflection film does not have to be formed on the back end surface 1b of the DFB laser 1 since the reflectance is improved with the help of the external reflector 3. Further, in the example shown in FIG. 16, the active region length of the DFB laser 1 is, for instance, approximately 80 μm.

Further, in the case of the present embodiment, since the reflective function region i.e., the external reflector 3 is disposed behind the active region 30, out of the front and back end surfaces 1a and 1b between which the active region 30 is interposed, the reflectance when looking at the front end surface from the side of the back end surface 1b is a reflectance including a reflection from the external reflector 3, in addition to a reflection by the back end surface 1b.

According to the third embodiment described above, the aforementioned first to seventh effects, the tenth effect, and the thirteenth effect can be obtained.

Further, in the third embodiment described above, the monitor PD function can be added to the external reflector 3 by forming an appropriate electrode on the external reflector 3 so that current can be extracted, and in this case, the aforementioned eighth effect can be obtained as well. Note that, since the reflectance of the end surface of the monitor PD and the external reflector 3 decreases in this case, it is necessary to lengthen the active region length of the DFB laser 1. Further, the monitor PD function may be added to one of the divided parts of the external reflector 3 or a plurality of the divided parts (for instance, it is preferred that the function be added to all the divided parts).

### FOURTH EMBODIMENT

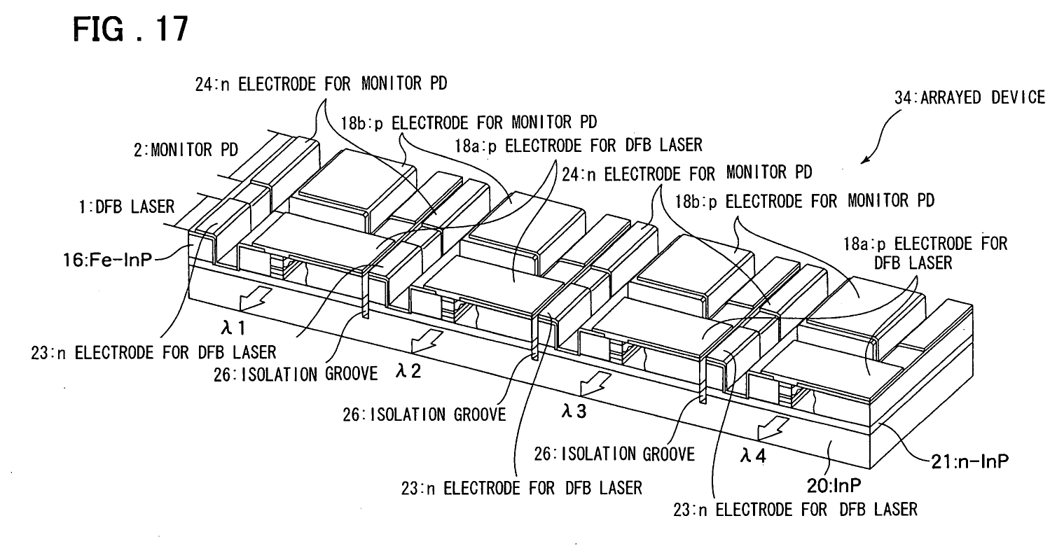

Further, a plurality of the DFB lasers 1 (FIG. 7) integrated with the monitor PD2 in one unit can be arrayed monolithically as shown in FIG. 17. In this case, p and n electrodes must be provided on the upper surface of an arrayed device 34. Because of this, the same layer structure as that of the aforementioned embodiments is formed and the device is formed and arrayed after an n-InP contact layer 21 is grown on a high resistance substrate 20 such as Fe—InP or the like.

For instance, when used for CWDM applications, the period of the diffraction grating 13 of each DFB laser 1 included in the arrayed device (distributed-feedback semiconductor laser array) 34 must be adjusted so that the oscillation wavelengths of the DFB lasers 1 differ by approximately 20 nm from one another. In other words, in the case of the arrayed device 34 comprising four DFB lasers 1 as shown in FIG. 17, the period of each diffraction grating 13 should be set so that the room temperature oscillation wavelengths are, for instance, λ1 (the first DFB laser 1)=1290 nm, λ2 (the second DFB laser 1)=1310 nm, λ3 (the third DFB laser 1)=1330 nm, and λ4 (the fourth DFB laser 1)=1350 nm.

Further, in order to independently drive each DFB laser 1 included in the arrayed device 34, isolation grooves 26 electrically insulate between all the DFB lasers 1. This isolation grooves 26 are formed by etching so that they reach inside the substrate 20.

Further, in order to avoid heat interferences between the active regions 30 of the DFB lasers 1, the intervals between the DFB lasers 1 (the pitches of the center positions of the active regions 30) are, for instance, not less than 500 μm.

Finally, as in the aforementioned first embodiment, the p electrodes 18a for the DFB laser and the p electrodes 18b for the monitor PD are formed, and further, n electrodes 23 for the DFB laser and n electrodes 24 for the monitor PD are also formed on the upper surface of the arrayed device 34. By doing this, each DFB laser 1 can be independently and directly modulated from the upper surface of the arrayed device 34.

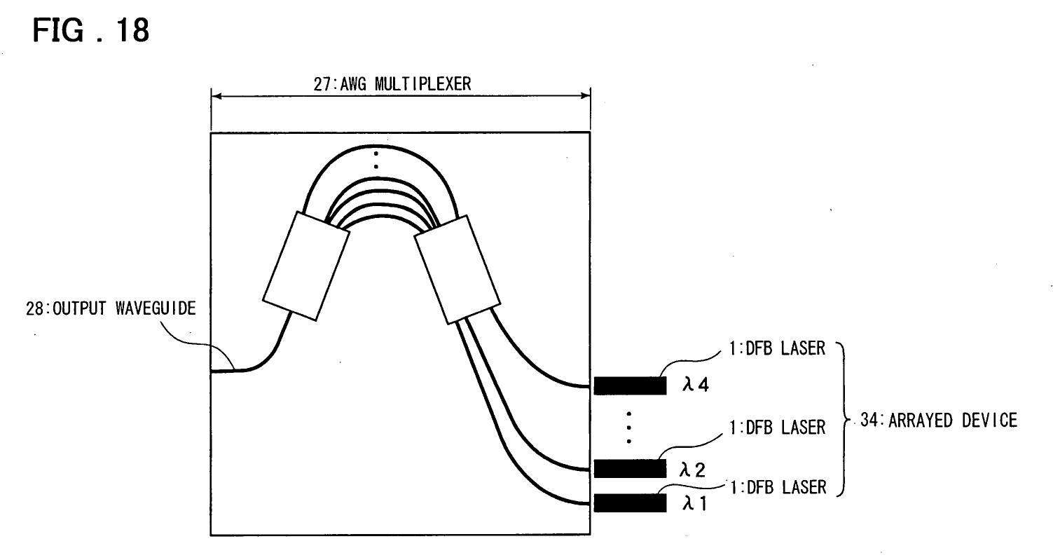

In the case of the fourth embodiment, since the n electrode 23 for the DFB laser and the n electrode 24 for the monitor PD must be formed connected to the n-InP contact layer 21 as shown in FIG. 18, a letter “h” (the mirror image of “h” in the case of FIG. 18) must be etched out during the etching process performed to change the state shown in FIG. 12 to the state shown in FIG. 13.

A DFB laser array light source suitable for CWDM applications can be realized by hybrid-integrating the arrayed device 34 obtained as described above with, for instance, an AWG multiplexer 27 as shown in FIG. 18 so that the total optical output (λ1 to λ4) can be extracted to an output waveguide 28, and connecting the output to a optical fiber.

Note that a dielectric filter and mirror, or a different multiplexer may be used instead of the AWG multiplexer 27 shown in FIG. 18.

According to the fourth embodiment as described above, the aforementioned first to ninth effects, the eleventh to thirteenth effects, and the fifteenth effect can be obtained.

Further, in addition to the examples described above, the present invention may be embodied as an optical module comprising the devices 29, 35, and 33 relating to the aforementioned first to third embodiments or the arrayed device 34 relating to the aforementioned fourth embodiment. In this case, the aforementioned sixteenth effect can be obtained.

1. A distributed-feedback semiconductor laser comprising an active region for generating the gain of a laser beam and a diffraction grating formed in said active region, wherein
the front end surface out of the front and back end surfaces between which said active region is interposed has a reflectivity of 1 percent or less, the back end surface out of said two end surfaces has a reflectivity of 30 percent or more when viewed from the back end surface side toward the front,
the coupling coefficient κ of said diffraction grating is 100 cm⁻¹ or more, the length L of said active region is 150 μm or less, and
a combination of κ and L so that these parameters provide Δα/gₜₕ of 1 or more, where Δα is the gain difference between modes and gₜₕ is a threshold gain.

2. The distributed-feedback semiconductor laser as defined in claim 1 wherein the product of said coupling coefficient κ and said active region length L is at least 1 and not more 3.

3. The distributed-feedback semiconductor laser as defined in claim 1 wherein the active region length L is not longer than Lp where Lp is the length of the active region provided that the dependency of Δα/gₜₕ on the active region length L is plotted and Δα/gₜₕ is on a peak in value.

4. The distributed-feedback semiconductor laser as defined in claim 1 wherein said diffraction grating is a gain coupled structure or loss coupled structure, or
has a structure in which two or three out of the gain coupled, loss coupled, and refractive index coupled structures are mixed, or
is of a structure that is refractive index coupled and λ/4 shifted.

5. The distributed-feedback semiconductor laser as defined in claim 1 wherein said diffraction grating has a structure that is refractive index coupled and λ/4 shifted, and the λ/4 shift position is at a distance backward from the front end of said active region by 75 percent±5 percent where the longitudinal direction length of said active region is 100 percent.

6. The distributed-feedback semiconductor laser as defined in claim 1 wherein the back end surface of said active region is formed by etching, and the longitudinal direction length of the entire device including the distributed-feedback semiconductor laser is longer than 150 μm.

7. The distributed-feedback semiconductor laser as defined in claim 6 wherein said device is so structured to include another function region integrated behind the distributed-feedback semiconductor laser through an end surface gap formed by said etching process.

8. The distributed-feedback semiconductor laser as defined in claim 7 wherein said other function region has a light-receiving function.

9. The distributed-feedback semiconductor laser as defined in claim 8 wherein the front end surface of said other function region is formed tilted relative to the back end surface of said active region.

10. The distributed-feedback semiconductor laser as defined in claim 7 wherein said other function region has a reflection function to said active region.

11. The distributed-feedback semiconductor laser as defined in claim 1 wherein the reflectivity of the back end surface of said active region is set to 90 percent or more.

12. The distributed-feedback semiconductor laser as defined in claim 11 wherein the reflectivity of the back end surface of said active region is set to 90 percent or more by providing a high-reflection film on said back end surface.

13. The distributed-feedback semiconductor laser as defined in claim 12 wherein a window that guides light out from said active region is formed on said high-reflection film.

14. The distributed-feedback semiconductor laser as defined in claim 1 wherein materials that constitute said active region comprise at lease one selected from the group of Al, N and Sb.

15. The distributed-feedback semiconductor laser as defined in claim 1 wherein the distributed-feedback semiconductor laser has a series resistance of 50 ohms±10 ohms.

16. A distributed-feedback semiconductor laser array monolithically comprising an array of the distributed-feedback semiconductor lasers as defined in claim 1 wherein the distributed-feedback semiconductor lasers have different wavelengths from one another.

17. An optical module that comprises the distributed-feedback semiconductor laser as defined in claim 1.

18. (canceled)

19. (canceled)

20. (canceled)

21. A distributed-feedback semiconductor laser wherein an external reflector is provided behind the distributed-feedback semiconductor laser as defined in claim 1.

22. (canceled)

23. An optical module that comprises the distributed-feedback semiconductor laser array as defined in claim 16.
